(19) United States
(12) Patent Application Publication
(10) Pub. No.: US 2009/0139786 A1
(43) Pub. Date: Jun. 4, 2009

(54) UNDERCOVER SYSTEM OF AN ENGINE COMPARTMENT OF A VEHICLE

(76) Inventor: Sung Ho Lee, Gwangmyeong-city (KR)

Correspondence Address: MORGAN, LEWIS & BOCKIUS LLP (SF), One Market, Spear Street Tower, Suite 2800, San Francisco, CA, 94105, US

(21) Appl. No.: 12/019,876

(22) Filed: Jan. 25, 2008

(30) Foreign Application Priority Data
Nov. 30, 2007 (KR) 10-2007-0123559

(51) Int. Cl. B60K 11/08

(52) U.S. Cl. 180/68.1

(57) ABSTRACT

An undercover system is attached to the bottom of a vehicle engine compartment. A cover has at least one inlet to introduce air from under the engine compartment into the engine compartment. The cover may have a downwardly slanted surface, and the inlet may be near the slanted surface. The inlet may include an opening, and a guide portion to guide the air toward the opening. The guide portion may have a corner pointing toward the front of the vehicle. The cover may also have an exhaust portion behind the inlet, to exhaust the air. The exhaust portion may include an exhaust guide plate slanted toward the engine compartment. The cover may also include an oil drain hole. An additional exhaust portion may be provided behind the exhaust portion.

### CROSS-REFERENCE TO RELATED APPLICATION

This application claims priority to, and the benefit of, Korean Patent Application No. 10-2007-0123559, filed in the Korean Intellectual Property Office on Nov. 30, 2007, the entire contents of which are incorporated herein by reference.

### BACKGROUND OF THE INVENTION

(a) Field of the Invention

The present invention relates to an undercover system of an engine compartment of a vehicle.

(b) Description of the Related Art

An undercover is sometimes provided at the bottom of a vehicle engine compartment. When an undercover is not provided, road noise is transmitted into the passenger compartment. Also, parts of the engine compartment may have shortened lifespans due to the introduction of dirt, or aerodynamic performance of the vehicle may suffer.

When an undercover is provided, heat is not sufficiently dissipated out of the engine compartment. For this reason, the undercover does not usually billy cover the bottom of the engine compartment, but typically covers only areas where major noises occur.

It is therefore desirable to provide an undercover system that provides both sufficient air flow in the engine compartment and sufficient sound insulation.

The above information disclosed in this Background section is only for enhancement of understanding of the background of the invention and therefore it may contain information that does not form the prior art that is already known in this country to a person of ordinary skill in the art.

### SUMMARY OF THE INVENTION

An undercover system is attached to the bottom of a vehicle engine compartment. A cover has at least one inlet to introduce air from under the engine compartment into the engine compartment.

The cover may have a downwardly slanted surface, and the inlet may be near the slanted surface. The inlet may include an opening, and a guide portion to Wide the air toward the opening. The guide portion may have a corner pointing toward the front of the vehicle.

The cover may also have an exhaust portion behind the inlet, to exhaust the air. The exhaust portion may include an exhaust guide plate slanted toward the engine compartment. The cover may also include an oil drain hole. An additional exhaust portion may be provided behind the exhaust portion.

### BRIEF DESCRIPTION OF THE DRAWINGS

FIG. 1 is a bottom view of an undercover system for a vehicle engine compartment according to an exemplary embodiment of the present invention.

FIG. 2 is a top view of the undercover system of FIG. 1.

FIG. 3(a) is a cross-sectional view taken along line A-A of FIG. 1.

FIG. 3(b) is a cross-sectional view taken along line B-B of FIG. 1.

FIG. 3(c) is a cross-sectional view taken along line C-C of FIG. 1.

FIG. 4 is a schematic view of air flow in and out of the engine compartment in a vehicle equipped with the undercover system of FIG. 1.

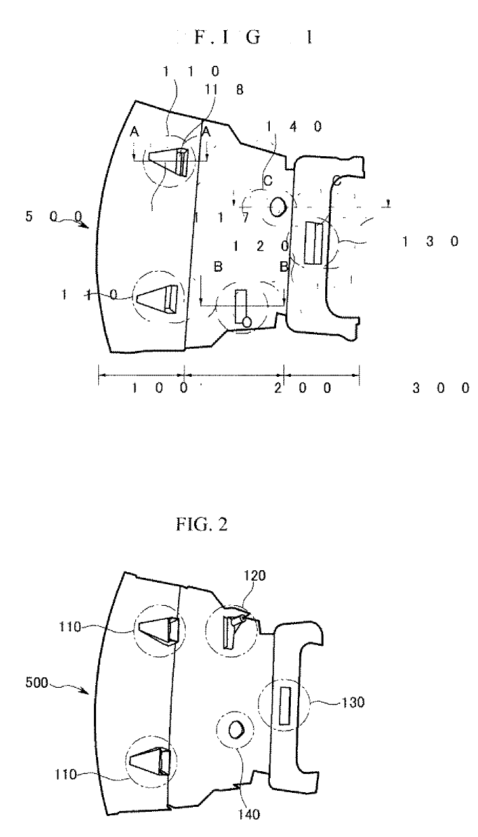

### DESCRIPTION OF REFERENCE NUMERALS INDICATING PRIMARY ELEMENTS IN THE DRAWINGS

| | |
|---|---|
| 500: undercover system | 100: the first main body |
| 200: the second main body | 300: the third main body |
| 110: inlet portion | 115: slanted surface |
| 117: guide portion | 118: inlet opening |
| 120: exhaust portion | 130: exhaust portion |
| 125: exhaust guide plate | 140: oil drain hole |
| 400: engine compartment | 405: bumper |
| 410: radiator | 420: engine |
| 430: exhaust system | 390: road |

### DETAILED DESCRIPTION OF PREFERRED EMBODIMENTS

An exemplary embodiment of the present invention will hereinafter be described in detail with reference to the accompanying drawings.

An undercover system 500 according to an exemplary embodiment of the present invention is provided at the bottom of an engine compartment 400 in order to isolate the engine compartment 400 from the lower side of the vehicle. The undercover system 500 includes a first main body 100, which includes at least one inlet portion 110 that takes in air from under the engine compartment 400.

Several inlet portions 110 may be symmetrically provided along the vehicle width direction. In the illustrated embodiment, two inlet portions 110 are provided, however, it should be understood that the present invention is not limited thereto.

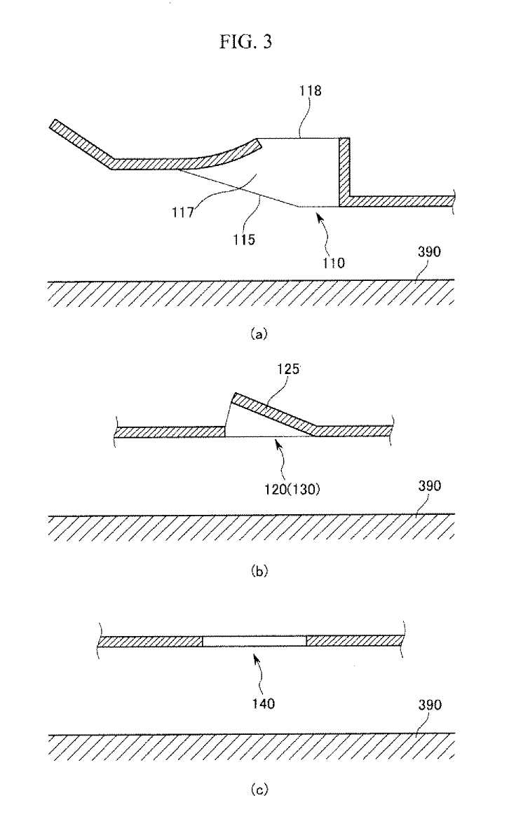

As shown in FIG. 3, according to an exemplary embodiment of the present invention, the first main body 100 includes a slanted surface 115 that is slanted downward toward a road 390. The inlet portion 110 is formed at the slanted surface 115. Therefore, the air that flows between the engine compartment 400 and the road 390 while the vehicle is running may be easily guided into the engine compartment 400.

In order to strengthen the guiding effect of the air into the engine compartment 400, the inlet portion 110 includes an inlet opening 118 that is open toward the engine compartment, and a guide portion 117 that guides air toward the inlet opening 118.

Referring back to FIG. 1, the guide portion 117 may be triangular with one corner pointing toward the vehicle front. This shape minimizes the amount that the inflow of the air into the engine compartment 400 affects the air flow under the engine compartment 400.

The undercover system 500 further includes a second main body 200 connected with the first main body 100 at a rear of the first main body 100. The second main body 200 includes an exhaust portion 120 that exhausts air from the engine compartment 400.

The second main body 200 may be connected with the first main body 100 in various ways, such as by a rivet or a screw fastener, or by being integrally formed.

An oil drain hole 140 may be provided on the second main body 200 for draining engine oil and extracting the oil filter from the engine compartment 400. The oil drain hole 140 may be at a location corresponding to an oil fan (not shown).

As shown in FIG. 3, the exhaust portion 120 according to an exemplary embodiment of the present invention includes an exhaust guide plate 125 slanting upward toward the engine compartment 400. The exhaust guide plate 125 ensures that the air in the engine compartment 400 is naturally and smoothly exhausted outward while the vehicle is running.

The undercover system 500 further includes a third main body 300 connected with the second main body 200 at a rear of the second main body 200. The third main body 300 includes an exhaust portion 130 that exhausts air from the engine compartment 400.

According to an exemplary embodiment of the present invention, the third main body 300 may be connected with the second main body 200 in various ways, such as by a rivet or a screw fastener, or by being integrally formed.

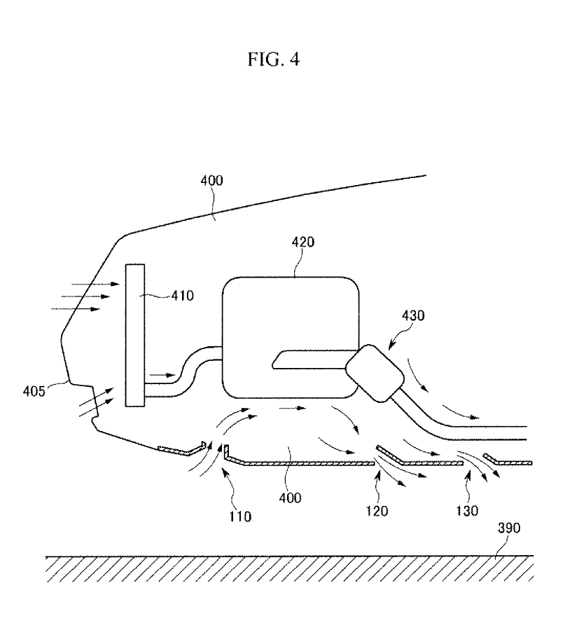

As shown in FIG. 4, while the vehicle is running, the air flows into the engine compartment 400 through openings above and below the bumper 405 so as to cool the radiator 410, and then flows through the engine compartment 400.

At the same time, air from under the engine compartment 400 enters the engine compartment 400 through the inlet portion 110, and then passes by the engine while flowing through the engine compartment 400.

The air flows rearward in the engine compartment 400. The air may be exhausted through the exhaust portions 120, 130. Heat of the engine 420 and exhaust system 430 may be sufficiently exhausted through the exhaust portions 120 and 130.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An undercover system configured to be attached to a bottom of an engine compartment, comprising:
a cover comprising at least one inlet configured to introduce air from under the engine compartment into the engine compartment.

2. The undercover system of claim 1, wherein the at least one inlet comprises a plurality of inlets.

3. The undercover system of claim 1, wherein the cover further comprises a downwardly slanted surface, wherein the inlet is disposed near the slanted surface.

4. The undercover system of claim 1, wherein the inlet comprises an opening, and a guide portion configured to guide the air toward the opening.

5. The undercover system of claim 4, wherein the guide portion comprises a corner pointing substantially toward a vehicle front.

6. The undercover system of claim 1, wherein the cover further comprises an exhaust portion configured to exhaust the air, disposed behind the inlet.

7. The undercover system of claim 6, wherein the exhaust portion comprises an exhaust guide plate slanted toward the engine compartment.

8. The undercover system of claim 1, wherein the cover further comprises an oil drain hole.

9. The undercover system of claim 6, further comprising an additional exhaust portion behind the exhaust portion, configured to exhaust the air.
